(19) United States
(12) Patent Application Publication
(10) Pub. No.: US 2011/0269858 A1
(43) Pub. Date: Nov. 3, 2011

(54) ELASTIC MOLDED FOAM BASED ON POLYOLEFIN/STYRENE POLYMER MIXTURES

(75) Inventors: Carsten Schips, Speyer (DE); Klaus Hahn, Kirchheim (DE); Konrad Knoll, Mannheim (DE); Holger Ruckdäschel, St. Martin (DE); Jens Assmann, Mannheim (DE); Georg Grässel, Ludwigshafen (DE); Maximilian Hofmann, Mannheim (DE)

(73) Assignee: BASF SE, Ludwigshafen (DE)

(21) Appl. No.: 13/143,029

(22) PCT Filed: Dec. 16, 2009
(86) PCT No.: PCT/EP2009/067260

§ 371 Date: Jun. 30, 2011

(30) Foreign Application Priority Data
Dec. 30, 2008 (EP) 08173084.8

(51) Int. Cl. C08L 53/02; C08J 9/18; C08L 23/02; C08L 25/04; C08J 9/12; C08J 9/224; B82Y 30/00

(52) U.S. Cl. 521/57; 264/54; 521/59; 977/773

(57) ABSTRACT

Expandable, thermoplastic polymer bead material, comprising
A) from 45 to 97.8 percent by weight of a styrene polymer,
B1) from 1 to 45 percent by weight of a polyolefin with a melting point in the range from 105 to 140° C.,
B2) from 0 to 25 percent by weight of a polyolefin with a melting point below 105° C.,
C1) from 0.1 to 25 percent by weight of a block or graft copolymer with weight-average molar mass M_{w} of at least 100,000 g/mol, comprising
   a) at least one block S composed of from 95 to 100% by weight of vinylaromatic monomers and from 0 to 5% by weight of dienes, and
   b) at least one copolymer block (S/B)_{A} composed of from 63 to 80% by weight of vinylaromatic monomers and from 20 to 37% by weight of dienes, with glass transition temperature Tg_{A} in the range from 5 to 30° C., where
      the proportion by weight of the entirety of all of the blocks S is in the range from 50 to 70% by weight, based on the block or graft copolymer A,
C2) from 0 to 20 percent by weight of a styrene-butadiene or styrene-isoprene block copolymer different from C1,
C3) from 0.1 to 9.9 percent by weight of a styrene-ethylene-butylene block copolymer,
D) from 1 to 15 percent by weight of a blowing agent, and
E) from 0 to 5 percent by weight of a nucleating agent,
   where the entirety composed of A) to E) gives 100% by weight.

The invention relates to an expandable, thermoplastic polymer bead material comprising
A) from 45 to 97.8 percent by weight of a styrene polymer,
B1) from 1 to 45 percent by weight of a polyolefin with a melting point in the range from 105 to 140° C.,
B2) from 0 to 25 percent by weight of a polyolefin with a melting point below 105° C.,
C1) from 0.1 to 25 percent by weight of a block or graft copolymer with weight-average molar mass of at least 100 000 g/mol, comprising
   a) at least one block S composed of from 95 to 100% by weight of vinylaromatic monomers and from 0 to 5% by weight of dienes, and
   b) at least one copolymer block (S/B)_{A} composed of from 63 to 80% by weight of vinylaromatic monomers and from 20 to 37% by weight of dienes, with glass transition temperature Tg_{A} in the range from 5 to 30° C., where
      the proportion by weight of the entirety of all of the blocks S is in the range from 50 to 70% by weight, based on the block or graft copolymer A,
C2) from 0 to 20 percent by weight of a styrene-butadiene or styrene-isoprene block copolymer different from C1,
C3) from 0.1 to 9.9 percent by weight of a styrene-ethylene-butylene block copolymer,
D) from 1 to 15 percent by weight of a blowing agent, and
E) from 0 to 5 percent by weight of a nucleating agent,
   where the entirety composed of A) to E) gives 100% by weight.

Expandable polymer mixtures composed of styrene polymers, polyolefins, and optionally solubilizers, such as hydrogenated styrene-butadiene block copolymers, are known by way of example from DE 24 13 375, DE 24 13 408, or DE 38 14 783. The foams obtainable therefrom are intended to have better mechanical properties when compared with foams composed of styrene polymers, in particular better elasticity and less brittleness at low temperatures, and also resistance to solvents, such as ethyl acetate and toluene. However, the ability to retain blowing agent and the foamability of the expandable polymer mixtures to give low densities are inadequate to meet the requirements of processing.

WO 2005/056652 describes molded foams with density in the range from 10 to 100 g/l which are obtainable via fusion of prefoamed foam beads derived from expandable, thermoplastic polymer pellets. The polymer pellets comprise mixtures composed of styrene polymers and of other thermoplastic polymers, and can be obtained via melt impregnation and subsequent pressurized underwater pelletization.

Elastic moldable foams composed of expandable interpolymer beads are also known (e.g. US 2004/0152795 A1). The interpolymers are obtainable via polymerization of styrene in the presence of polyolefins in aqueous suspension, and form an interpenetrating network composed of styrene polymers and of olefin polymers. However, the blowing agent diffuses rapidly out of the expandable polymer beads, and they therefore have to be stored at low temperatures, and have only a short period of adequate foamability.

WO 2005/092959 describes nanoporous polymer foams which are obtainable from multiphase polymer mixtures which comprise blowing agent and which have domains in the range from 5 to 200 nm. The domains are preferably composed of a core-shell particle obtainable via emulsion polymerization, and the solubility of the blowing agent in these is at least twice as high as in the adjacent phases.

It was an object of the present invention to provide expandable, thermoplastic polymer bead material with low loss of blowing agent and with high expansion capability, processible to give molded foams with high stiffness together with good elasticity, and also to provide a process for production of this material.

Accordingly, the expandable thermoplastic polymer bead material described above has been found.

The expandable, thermoplastic polymer bead material preferably comprises
A) from 55 to 89.7 percent by weight of a styrene polymer,
B1) from 4 to 25 percent by weight of a polyolefin with a melting point in the range from 105 to 140° C.,
B2) from 1 to 15 percent by weight of a polyolefin with a melting point below 105° C.,
C1) from 3 to 25 percent by weight,
C2) from 3 to 20 percent by weight,
C3) from 1 to 5 percent by weight of a styrene-ethylene-butylene block copolymer,
D) from 3 to 10 percent by weight of a blowing agent, and
E) from 0.3 to 3 percent by weight of a nucleating agent,
   where the entirety composed of A) to E) gives 100% by weight.

Accordingly, the expandable thermoplastic polymer bead material described above has been found.

The expandable, thermoplastic polymer bead material comprises from 45 to 97.8% by weight, particularly preferably from 55 to 89.7% by weight, of a styrene polymer A), such as standard polystyrene (GPPS) or impact resistant polystyrene (HIPS), or styrene-acrylonitrile copolymers (SAN), or acrylonitrile-butadiene-styrene copolymers (ABS). Particular preference is given to standard polystyrene grades with weight-average molar masses in the range from 120 000 to 300 000 g/mol and with a melt volume rate MVR (200° C./5 kg) to ISO 1133 in the range from 1 to 10 cm³/10 min, examples being PS 158 K, 168 N, or 148 G from BASF Aktiengesellschaft. Free-flowing grades can be added in order to improve the fusion of the foam beads during processing to give the molding, an example being Empera® 156L (Innovene).

The expandable thermoplastic polymer bead material comprises, as further components B), polyolefins B1) with a melting point in the range from 105 to 140° C., and polyolefins B2) with a melting point below 105° C. The melting point is the melting peak determined by means of DSC (Dynamic Scanning calorimetry), at a heating rate of 10° C./minute.

The expandable, thermoplastic polymer bead material comprises from 1 to 45 percent by weight, in particular from 4 to 35% by weight, of a polyolefin B1). Preferred polyolefin B1) is a homo- or copolymer of ethylene and/or propylene, with density in the range from 0.91 to 0.98 g/L (determined to ASTM D792), in particular polyethylene. Particular polypropylenes that can be used are injection-molding grades. Polyethylenes that can be used are commercially available homopolymers composed of ethylene, e.g. LDPE (injection-molding grades), LLDPE, HDPE, or copolymers composed of ethylene and propylene (e.g. Moplen® RP220 and Moplen® RP320 from Basell), ethylene and vinyl acetate (EVA), ethylene-acrylates (EA), or ethylene-butylene-acrylates (EBA). The melt volume index MVI (190° C./2.16 kg) of the polyethylenes is usually in the range from 0.5 to 40 g/10 min, and the densities are usually in the range from 0.91 to 0.95 g/cm³. Blends with polyisobutene (PIB) can moreover be used (e.g. Oppanol® B150 from BASF SE). It is particularly preferable to use LLDPE with a melting point in the range from 110 to 125° C. and with density in the range from 0.92 to 0.94 g/L.

With a relatively small proportion of polyolefin B1), blowing-agent-retention capability increases markedly. With this, the storage capability and the processability of the expandable, thermoplastic polymer bead material are markedly improved. In the range from 4 to 20% by weight of polyolefin, expandable thermoplastic polymer bead material with long-term storage capability is obtained, without any impairment of the elastic properties of the molded foam produced therefrom. This is apparent by way of example in a relatively low compression set εₛₑₜ in the range from 25 to 35%.

The expandable, thermoplastic polymer bead material comprises, as polyolefin B2), from 0 to 25 percent by weight, in particular from 1 to 15% by weight, of a polyolefin B2). The density of the polyolefin B2) is preferably in the range from 0.86 to 0.90 g/L (determined to ASTM D792). Thermoplastic elastomers based on olefins (TPOs) are particularly suitable for this purpose. Particular preference is given to ethylene-octene copolymers which are commercially obtainable by way of example as Engage® 8411 from Dow. When expandable, thermoplastic polymer bead materials comprising component B2) have been processed to give foam moldings they show a marked improvement in bending energy and ultimate tensile strength.

It is known from the sector of multiphase polymer systems that most polymers have no, or only slight, miscibility with one another (Flory), and the result, as a function of temperature, pressure, and chemical constitution, is therefore separation to give the respective phases. If incompatible polymers are covalently linked to one another, the separation does not take place at the macroscopic level, but only at the microscopic level, i.e. on the scale of the length of the individual polymer chains. In this case, the term used is microphase separation. The result of this is a wide variety of mesoscopic structures, e.g. lamellar, hexagonal, cubic, and bicontinuous morphologies, which are closely related to lyotropic phases.

For controlled establishment of the desired morphology, compatibilizers (components C) are used. According to the invention, compatibility is improved via the use of a mixture of styrene-butadiene block copolymers or styrene-isoprene block copolymers, as component C1), and styrene-ethylene-butylene block copolymers (SEBS), as component C2).

The compatibilizers lead to improved adhesion between the polyolefin-rich and the styrene-polymer-rich phase, and even small amounts improve the elasticity of the foam in comparison with conventional EPS foams. Studies on the domain size of the polyolefin-rich phase showed that the compatibilizer stabilizes small droplets via a reduction in interfacial tension.

### Component C1:

The expandable, thermoplastic polymer bead material comprises, as component C1, a block copolymer or graft copolymer which comprises
a) at least one block S composed of from 95 to 100% by weight of vinylaromatic monomers and from 0 to 5% by weight of dienes, and
b) at least one copolymer block (S/B)_{A} composed of from 63 to 80% by weight of vinylaromatic monomers and from 20 to 37% by weight of dienes, with glass transition temperature Tg_{A} in the range from 5 to 30° C.

Examples of vinylaromatic monomers that can be used are styrene, alpha-methylstyrene, ring-alkylated styrenes, such as p-methylstyrene, or tert-butylstyrene, or 1,1-diphenylethylene, or a mixture thereof. It is preferable to use styrene.

Preferred dienes are butadiene, isoprene, 2,3-dimethylbutadiene, 1,3-pentadiene, 1,3-hexadiene, or piperylene, or a mixture of these. Particular preference is given to butadiene and isoprene.

The weight-average molar mass M_{w} of the block copolymer or graft copolymer is preferably in the range from 250 000 to 350 000 g/mol.

The blocks S are preferably composed of styrene units. In the case of the polymers produced via anionic polymerization, the molar mass is controlled by way of the ratio of amount of monomer to amount of initiator. However, initiator can also be added a number of times after completion of monomer feed, the product then having bi- or multimodal distribution. In the case of polymers produced by a free-radical route, the weight-average molecular weight M_{W} is set by way of the polymerization temperature and/or addition of regulators.

The glass transition temperature of the copolymer block (S/B)_{A} is preferably in the range from 5 to 20° C. The glass transition temperature is affected by the comonomer constitution and comonomer distribution, and can be determined via Differential Scanning calorimetry (DSC) or Differential Thermal Analysis (DTA), or can be calculated from the Fox equation. The glass transition temperature is generally determined using DSC to ISO 11357-2 at a heating rate of 20K/min.

The copolymer block (S/B)_{A} is preferably composed of from 65 to 75% by weight of styrene and from 25 to 35% by weight of butadiene.

Preference is given to block copolymers or graft copolymers which comprise one of more copolymer blocks (S/B)_{A} composed of vinylaromatic monomers and dienes with random distribution. These can by way of example be obtained via anionic polymerization using alkyllithium compounds in the presence of randomizers, such as tetrahydrofuran, or potassium salts. Preference is given to potassium salts, using a ratio of anionic initiator to potassium salt in the range from 25:1 to 60:1. Particular preference is given to cyclohexane-soluble alcoholates, such as potassium tert-butylamyl alcoholate, these being used in a lithium-potassium ratio which is preferably from 30:1 to 40:1. This method can simultaneously achieve a low proportion of 1,2-linkages of the butadiene units.

The proportion of 1,2-linkages of the butadiene units is preferably in the range from 8 to 15%, based on the entirety of 1,2-, 1,4-cis-, and 1,4-trans linkages.

The weight-average molar mass M_{w} of the copolymer block (S/B)_{A} is generally in the range from 30 000 to 200 000 g/mol, preferably in the range from 50 000 to 100 000 g/mol.

Random copolymers (S/B)_{A} can, however, also be produced via free-radical polymerization.

The blocks (S/B)_{A} form a semi-hard phase in the molding composition at room temperature (23° C.), and this is responsible for the high ductility and tensile strain at break values, i.e. high elongation at low strain rate.

The graft polymers can be divided into two types: type 1) is composed of a main chain composed of a random S/B polymer and polystyrene graft branches, while type 2) has a polystyrene main chain having S/B side groups. Type 1) is preferred.

There are a number of synthesis strategies for the production of graft polymers of this type:

(i) Graft branch in the form of macromonomer, which is by way of example copolymerized by a free-radical route with further monomers.

Synthesis method: Use of an initiator or regulator having an OH or NH₂ group. Example of initiator: hydrogen peroxide; example of regulator: thioethanolamine or HS—CH₂—(CH₂)n-OH. The molecular weight can be adjusted by way of the amount of regulator and the temperature. It is thus possible to obtain end-group-functionalized polystyrene and, respectively, S/B. A copolymerizable acrylic or methacrylic group is introduced by reaction with acryloyl chloride or methacryloyl chloride, with formation of an ester group or amide group. The macromonomer is then dissolved in styrene or in a mixture composed of styrene and butadiene, and polymerized either thermally or using a free-radical initiator and, if appropriate, a regulator.

(ii) Graft branch having functional end group and main chain having reactive group or groups.

Synthesis method: The main chain can be copolymerized with small amounts of reactive monomer, e.g. maleic anhydride. The graft branch is regulated as with a), for example using a thioethanolamine, and then reacted with the main chain with formation of an amide, which gives a highly stable imide on heating.

(iii) Direct free-radical grafting onto main chain via generation of a free radical on the main chain

### Synthesis Method:

1) S/B main chain: Grafting of polystyrene onto S/B main chain either thermally or using free-radical initiator, preferably under controlled free-radical conditions, for example with addition of TEMPO
2) Introduction of functional groups at the main chain via copolymerization using functional monomers (hydroxyethyl methacrylate, etc.), followed by introduction of free-radical initiator at the main chain.
(iv) Grafting of carbanion onto main chain

Synthesis method; Production of a main chain having a few monomer units which are reactive toward carbanions, examples being carbonyl compounds, such as esters. anhydrides, or nitriles, epoxides, etc. Examples of monomers for this purpose are acrylates, methacrylates, acrylonitrile, etc. The main monomer can be styrene, for example. Monomers having leaving groups can moreover be used, an example being chloromethyl groups. However, it is also possible that the entire main chain is an acrylate copolymer, for example MMA/n-butyl acrylate, the monomer ratio here being selected in such a way that the Tg of the polymer is about 20° C., i.e. about 40/60 by weight.

The branch is separately produced via living anionic polymerization, and added to the main chain produced by a free-radical route. Preference is given to styrene and its derivatives. The product is then an MMA/nBA-g-styrene graft copolymer.

The block copolymers or graft copolymers C1 can also comprise

(v) at least one homopolydiene (B) block or copolymer block (S/B)_{B} composed of from 20 to 60% by weight, preferably from 1 to 60% by weight, of vinylaromatic monomers and from 40 to 99% by weight, preferably from 40 to 80% by weight of dienes, with glass transition temperature Tg_{B} in the range from 0 to −110° C.

The glass transition temperature of the copolymer block (S/B)_{A} is preferably in the range from −60 to −20° C. The glass transition temperature is affected by the comonomer constitution and comonomer distribution, and can be determined via Differential Scanning calorimetry (DSC) or Differential Thermal Analysis (DTA), or can be calculated from the Fox equation. The glass transition temperature is generally determined using DSC to ISO 11357-2 with a heating rate of 20K/min.

The copolymer block (S/B)_{A} is preferably composed of from 30 to 50% by weight of styrene and from 50 to 70% by weight of butadiene.

Preference is given to block copolymers or graft copolymers which comprise one of more copolymer blocks (S/B)_{B} composed of vinylaromatic monomers and dienes with random distribution. These can by way of example be obtained via anionic polymerization using alkyllithium compounds in the presence of randomizers, such as tetrahydrofuran, or potassium salts. Preference is given to potassium salts, using a ratio of anionic initiator to potassium salt in the range from 25:1 to 60:1. This method can simultaneously achieve a low proportion of 1,2-linkages of the butadiene units.

The proportion of 1,2-linkages of the butadiene unit is preferably in the range from 8 to 15%, based on the entirety of 1,2-, 1,4-cis-, and 1,4-trans linkages.

Random copolymers (S/B)_{B} can, however, also be produced via free-radical polymerization.

The blocks B and/or (S/B)_{B} forming a soft phase can be uniform over their entire length or can have division into differently constituted sections. Preference is given to sections having diene (B) and (S/B)_{B} which can be combined in various sequences. Gradients are possible, having continuously changing monomer ratio, and the gradient here can begin with pure diene or with a high proportion of diene, with styrene proportion rising as far as 60%. A sequence of two or more gradient sections is also possible. Gradients can be generated by reducing or increasing the amount added of the randomizer. It is preferable to set a lithium-potassium ratio greater than 40:1 or, if tetrahydrofuran (THF) is used as randomizer, to use an amount of THF less than 0.25% by volume, based on the polymerization solvent. An alternative is simultaneous feed of diene and vinylaromatic compound at a slow rate, based on the polymerization rate, the monomer ratio being controlled here in accordance with the desired constitution profile along the soft block.

The weight-average molar mass M_{w} of the copolymer block (S/B)_{B} is generally in the range from 50 000 to 100 000 g/mol, preferably in the range from 10 000 to 70 000 g/mol.

The proportion by weight of the entirety of all of the blocks S in the range from 50 to 70% by weight, and the proportion by weight of the entirety of all of the blocks (S/B)_{A} and (S/B)_{B} is in the range from 30 to 50% by weight, based in each case on the block copolymer or graft copolymer.

There is preferably a block S separating blocks (S/B)_{A} and (S/B)_{B} from one another.

The ratio by weight of the copolymer blocks (S/B)_{A} to the copolymer blocks (S/B)_{B} is preferably in the range from 80:20 to 50:50.

Preference is given to block copolymers having linear structures, in particular those having the block sequence

S₁-(S/B)_{A}-S₂ (triblock copolymers)

### S₁-(S/B)_{A}-S₂-(S/B)_{B}-S₃, or

S₁-(S/B)_{A}-S₂-(S/B)_{A}-S₃ (pentablock copolymers),
where each of S₁ and S₂ is a block S.

These feature a high modulus of elasticity of from 1500 to 2000 MPa, high yield stress in the range from 35 to 42 MPa, and tensile strain at break above 30%, in mixtures using a proportion of more than 80% by weight of polystyrene. By way of comparison, commercial SBS block copolymers having this proportion of polystyrene have a tensile strain at break value of only from 3 to 30%.

Preference is given to triblock copolymers of the structure S₁-(S/B)_{A}-S₂, which comprise a block (S/B)_{A} composed of from 70 to 75% by weight of styrene units and from 25 to 30% by weight of butadiene units. Glass transition temperatures can be determined using DSC, or calculated from the Gordon-Taylor equation, and for this constitution are in the range from 1 to 10° C. The proportion by weight of the blocks S₁ and S₂, based on the triblock copolymer, is in each case preferably from 30% to 35% by weight. The total molar mass is preferably in the range from 150 000 to 350 000 g/mol, particularly preferably in the range from 200 000 to 300 000 g/mol.

Preference is given to pentablock copolymers of the structure S₁-(S/B)_{A}-S₂-(S/B)_{A}-S₃, which comprise a block (S/B)_{A} composed of from 70 to 75% by weight of styrene units and from 25 to 30% by weight of butadiene units. Glass transition temperatures can be determined using DSC, or calculated from the Gordon-Taylor equation, and for this constitution are in the range from 1 to 10° C. The proportion by weight of the entirety of the blocks S₁ and S₂, based on the pentablock copolymer, is in each case preferably from 50% to 67% by weight. The total molar mass is preferably in the range from 260 000 to 350 000 g/mol. Tensile strain at break values of up to 300% with a proportion of more than 85% of styrene can be achieved here by virtue of the molecular architecture.

The block copolymers A can moreover have a star-shaped structure which comprises the block sequence S₁-(S/B)_{A}-S₂—X—S₂-(S/B)_{A}-S₁, where each of S₁ and S₂ is a block S, and X is the radical of a polyfunctional coupling agent. An example of a suitable coupling agent is epoxidized vegetable oil, such as epoxidized linseed oil or epoxidized soybean oil. The product in this case is stars having from 3 to 5 branches. The average constitution of the star-shaped block copolymers is preferably two S₁-(S/B)_{A}-S₂-arms and two S₃ blocks linked by way of the radical of the coupling agent, and the block copolymers mainly comprise the structure S₁-(S/B)_{A}-S₂—X(S₃)₂—S₂-(S/B)_{A}-S₁, where S₃ is a further S block. The molecular weight of the block S₃ should be smaller than that of the blocks S₁. The molecular weight of the block S₃ preferably corresponds to that of the block S₂.

These star-shaped block copolymers can by way of example be obtained via double initiation, adding an amount 11 of initiator together with the vinylaromatic monomers needed for formation of the blocks S₁, and an amount I₂ of initiator together with the vinylaromatic monomers needed for formation of the S₂ blocks and S₃ blocks, after completion of the polymerization of the (S/B)_{A} block. The molar I₁/I₂ ratio is preferably from 0.5:1 to 2:1, particularly preferably from 1.2:1 to 1.8:1. The molar mass distribution of the star-shaped block copolymers is generally broader than that of the linear block copolymers. This leads to improved transparency, at constant flowability.

Block copolymers or graft copolymers which are composed of the blocks S, (S/B)_{A}, and (S/B)_{B}, for example pentablock copolymers of the structure S₁-(S/B)_{A}-S₂-(S/B)_{A}, form co-continuous morphology. Here, there are three different phases combined in one polymer molecule. The soft phase formed from the (S/B)_{B} blocks provides the impact resistance in the molding composition, and can prevent propagation of cracks (crazes). The semi-hard phase formed from the blocks (S/B)_{A} is responsible for the high ductility and tensile strain at break values. Modulus of elasticity and yield stress can be adjusted by way of the proportion of the hard phase formed from the blocks S and optionally admixed polystyrene.

The block copolymers or graft copolymers of the invention generally form highly transparent, nanodisperse, multiphase mixtures with standard polystyrene.

The expandable, thermoplastic polymer bead material comprises, as component C2), from 0.1 to 9.9 percent by weight, in particular from 1 to 5% by weight, of a styrene-butadiene or styrene-isoprene block copolymer different from C1.

Examples of those suitable for this purpose are styrene-butadiene or styrene-isoprene block copolymers. Total diene content is preferably in the range from 20 to 60% by weight, particularly preferably in the range from 30 to 50% by weight, and total styrene content is correspondingly preferably in the range from 40 to 80% by weight, particularly preferably in the range from 50 to 70% by weight.

Suitable styrene-butadiene block copolymers which are composed of at least two polystyrene blocks S and of at least one styrene-butadiene copolymer block S/B are by way of example the star-shaped branched block copolymers described in EP-A 0654488.

Other suitable materials are block copolymers having at least two hard blocks S₁ and S₂ composed of vinylaromatic monomers, and having, between these, at least one random soft block B/S composed of vinylaromatic monomers and diene, where the proportion of the hard blocks is above 40% by weight, based on the entire block copolymer, and the 1,2-vinyl content in the soft block B/S is below 20%, these being described in WO 00/58380.

Other suitable compatibilizers are linear styrene-butadiene block copolymers whose general structure is S-(S/B)-S having one or more (S/B)_{random} blocks which have random styrene/butadiene distribution, between the two S blocks. Block copolymers of this type are obtainable via anionic polymerization in a non-polar solvent with addition of a polar cosolvent or of a potassium salt, as described by way of example in WO 95/35335 or WO 97/40079.

The vinyl content is the relative proportion of 1,2-linkages of the diene units, based on the total of the 1,2-, 1,4-cis, and 1,4-trans linkages. The 1,2-vinyl content in the styrene-butadiene copolymer block (S/B) is preferably below 20%, in particular in the range from 10 to 18%, particularly preferably in the range from 12 to 16%.

Compatibilizers preferably used are styrene-butadiene-styrene (SBS) triblock copolymers whose butadiene content is from 20 to 60% by weight, preferably from 30 to 50% by weight, and these may be hydrogenated or non-hydrogenated materials. These are marketed by way of example as Styroflex® 2G66, Styrolux® 3G55, Styroclear® GH62, Kraton® D 1101, Kraton® D 1155, Tuftec® H1043, or Europren® SOL T6414. They are SBS block copolymers with sharp transitions between B blocks and S blocks.

The expandable, thermoplastic polymer bead material comprises, as component C3), from 0.1 to 9.9 percent by weight, in particular from 1 to 5% by weight, of a styrene-ethylene-butylene block copolymer (SEBS). Examples of suitable styrene-ethylene-butylene block copolymers (SEBS) are those obtainable via hydrogenation of the olefinic double bonds of the block copolymers C1). Examples of suitable styrene-ethylene-butylene block copolymers are the Kraton® G grades obtainable commercially, in particular Kraton® G 1650.

The following additions can moreover be made to the multiphase polymer mixture: additives, nucleating agents, plasticizers, flame retardants, soluble and insoluble inorganic and/or organic dyes and pigments, fillers, or co-blowing agents, in amounts which do not impair domain formation and foam structure resulting therefrom.

The expandable, thermoplastic polymer bead material comprises, as component E), from 0 to 5 percent by weight, preferably from 0.3 to 3 percent by weight, of a nucleating agent, such as talc.

The expandable, thermoplastic polymer bead material comprises, as blowing agent (component D), from 1 to 15 percent by weight, preferably from 3 to 10 percent by weight, based on components A) to E), of a physical blowing agent, such as aliphatic C₃-C₈ hydrocarbons, alcohols, ketones, ethers, or halogenated hydrocarbons. Preference is given to isobutane, n-butane, isopentane, or n-pentane.

Suitable co-blowing agents are those having relatively low selectivity of solubility for the phase forming domains, examples being gases, such as CO₂, N₂, and fluorocarbons, or noble gases. The amounts preferably used of these are from 0 to 10% by weight, based on the expandable, thermoplastic polymer bead material.

The polymer mixture with a continuous and a disperse phase can be produced via mixing of two incompatible thermoplastic polymers, for example in an extruder.

The expandable thermoplastic polymer bead material of the invention can be obtained via a process of
a) producing a polymer mixture with a continuous and a disperse phase via mixing of components A) to C) and optionally E),
b) impregnating these mixtures with a blowing agent D) and pelletizing them to give expandable thermoplastic polymer bead material, and
c) pelletizing via underwater pelletization at a pressure in the range from 1.5 to 10 bar, to give expandable, thermoplastic polymer bead material.

The average diameter of the disperse phase of the polymer mixture produced in stage a) is preferably in the range from 1 to 2000 nm, particularly preferably in the range from 100 to 1500 nm.

In another embodiment, the polymer mixture can also first be pelletized in stage b), and the pellets can then be post-impregnated with a blowing agent D) in aqueous phase, under pressure and at an elevated temperature, to give expandable thermoplastic polymer bead material. This can then be isolated after cooling below the melting point of the polymer matrix, or can be obtained directly in the form of prefoamed foam bead material via depressurization.

Particular preference is given to a continuous process in which, in stage a), a thermoplastic styrene polymer A) forming the continuous phase, for example polystyrene, is melted in a twin-screw extruder, and to form the polymer mixture is mixed with a polyolefin B1 and B2) forming the disperse phase, and also with the compatibilizers C1) and C2) and optionally nucleating agent E), and then the polymer melt is conveyed in stage b) through one or more static and/or dynamic mixing elements, and is impregnated with the blowing agent D). The melt loaded with blowing agent can then be extruded through an appropriate die, and cut, to give foam sheets, foam strands, or foam bead material.

An underwater pelletization system (UWPS) can also be used to cut the melt emerging from the die directly to give expandable polymer bead material or to give polymer bead material with a controlled degree of incipient foaming. Controlled production of foam bead material is therefore possible by setting the appropriate counterpressure and an appropriate temperature in the water bath of the UWPS.

Underwater pelletization is generally carried out at pressures in the range from 1.5 to 10 bar to produce the expandable polymer bead material. The die plate generally has a plurality of cavity systems with a plurality of holes. A hole diameter in the range from 0.2 to 1 mm gives expandable polymer bead material with the preferred average bead diameter in the range from 0.5 to 1.5 mm. Expandable polymer bead material with a narrow particle size distribution and with an average particle diameter in the range from 0.6 to 0.8 mm leads to better filling of the automatic molding system, where the design of the molding has relatively fine structure. This also gives a better surface on the molding, with smaller volume of interstices.

The resultant round or oval particles are preferably foamed to a diameter in the range from 0.2 to 10 mm. Their bulk density is preferably in the range from 10 to 100 g/l.

A preferred polymer mixture is obtained in stage a) via mixing of
A) from 45 to 98.8 percent by weight, in particular from 55 to 89% by weight, of styrene polymer,
B1) from 1 to 45 percent by weight, in particular from 4 to 25% by weight, of polyolefin whose melting point is in the range from 105 to 140° C.,
B2) from 0 to 25 percent by weight of a polyolefin whose melting point is below 105° C.,
C1) from 0.1 to 9.9 percent by weight of a styrene-butadiene block copolymer or styrene-isoprene block copolymer,
C2) from 0.1 to 9.9 percent by weight of a styrene-ethylene-butylene block copolymer,
E) from 0 to 5 percent by weight of a nucleating agent,
   and
   is impregnated in stage c) with from 1 to 15% by weight of a blowing agent D), where the entirety composed of A) to E) gives 100% by weight.

To improve processability, the finished expandable thermoplastic polymer bead material can be coated with glycerol ester, with antistatic agents, or with anticaking agent.

The fusion of the prefoamed foam beads to give the molding and the resultant mechanical properties are in particular improved via coating of the expandable thermoplastic polymer bead material with a glycerol stearate. Particular preference is given to use of a coating composed of from 50 to 100% by weight of glycerol tristearate (GTS), from 0 to 50% by weight of glycerol monostearate (GMS), and from 0 to 20% by weight of silica.

The expandable, thermoplastic polymer bead material of the invention can be prefoamed using hot air or steam to give foam beads whose density is in the range from 8 to 200 kg/m³, preferably in the range from 10 to 50 kg/m³, and can then be fused in a closed mold to give foam moldings. The processing pressure selected here is sufficiently low as to retain domain structure in the cell membranes fused to give foam moldings. The pressure is usually in the range from 0.5 to 1.0 bar.

The thermoplastic molded foams that can be obtained in this way preferably have cells whose average cell size is in the range from 50 to 250 μm, and an oriented fibrous disperse phase in the cell walls of the thermoplastic molded foams with an average diameter in the range from 10 to 1000 nm, particularly preferably in the range from 100 to 750 nm.

### EXAMPLES

### Starting Materials

### Component A:

PS 158K polystyrene from BASF SE

### Component B:

B1: LLDPE (726 N, Exxon Mobil, density 0.925 g/L, MVI=0.7 g/10 min, melting point 123° C.)
B2: Ethylene-octene copolymer (Engage® 8411 from Dow, density 0.880 g/L, MVI=18 g/10 min, melting point 72° C.)

### Component C:

C1-1: Styrene-butadiene block copolymer of structure S₁-(S/B)_{A}-S₂-(S/B)_{A}-S₁, (20-20-20-20-20% by weight), weight-average molar mass 300 000 g/mol
C2: Kraton® G 1650, styrene-ethylene-butylene block copolymer from Kraton Polymers LLC
C3: Styrolux® 3G55, styrene-butadiene block copolymer from BASF SE,
Component D: Blowing agent: pentane S (20% of isopentane, 80% of n-pentane)

### Component E: Talc (HP 320, Omyacarb)

### Production of Block Copolymer C1-1

For production of the linear styrene-butadiene block copolymer C1-1, 5385 ml of cyclohexane was used as initial charge in a 10 liter double-walled stirred stainless-steel autoclave with cross-blade stirrer, and titrated to the end point with 1.6 ml of sec-butyllithium (BuLi) at 60° C., until a yellow coloration appeared, brought about by 1,1-diphenylethylene used as indicator, and 3.33 ml of a 1.4 M sec-butyllithium solution were then admixed for initiation, and 0.55 ml of a 0.282 M potassium tert-amyl alcoholate (PTAA) solution was admixed as randomizer. The amount of styrene (280 g of styrene 1) necessary for the production of the first S block was then added and polymerized to completion. The further blocks were attached in accordance with the structure and constitution indicated via sequential addition of the appropriate amounts of styrene or styrene and butadiene, in each case with complete conversion. For production of the copolymer blocks, styrene and butadiene were added simultaneously in a plurality of portions, and the maximum temperature was limited to 77° C. by countercurrent cooling. For block copolymer K1-3, 84 g of butadiene 1 and 196 g of styrene 2 were used for the block (S/B)_{A}, 280 g of styrene 3 were used for the block S₂, 84 g of butadiene B2 and 196 g of styrene 4 were used for the block (S/B)_{A} and 280 g of styrene 5 were used for the block S₁.

The living polymer chains were then terminated via addition of 0.83 ml of isopropanol, and 1.0% of CO₂/0.5% of water, based on solids, were used for acidification, and a stabilizer solution (0.2% of Sumilizer GS and 0.2% of Irganox 1010, based in each case on solids) was added. The cyclohexane was removed by evaporation in a vacuum oven.

Weight-average molar mass M_{w} for the block copolymers K1-1 to K1-7 is in each case 300 000 g/mol.

### Comparative Example CE1

In a Leistritz ZSK 18 twin-screw extruder, 84 parts of polystyrene 158K, 8 parts of polyethylene 726N, 5 parts of Engage 8411 polyethylene, and 1.75 parts of Kraton G1650 were melted at from 220 to 240° C. and from 180 to 190 bar. 7.5 parts of S pentane (20% of isopentane, 80% of n-pentane) were then injected as blowing agent into the polymer melt, and homogeneously incorporated into the polymer melt by way of two static mixers. The temperature was then reduced to from 180° to 185° C. by way of a cooler. 1 part of talc, in the form of a masterbatch, was fed by way of an ancillary extruder as nucleating agent (see table 1) into the main melt stream loaded with blowing agent. After homogenization by way of two further static mixers, the melt was cooled to 155° C. and extruded through a heated pelletizing die (4 holes with 0.65 mm bore and pelletizing-die temperature of 280° C.). The polymer strand was chopped by means of an underwater pelletizer (underwater pressure 12 bar, water temperature 45° C.), thus giving minipellets loaded with blowing agent and having narrow particle size distribution (d′=1.1 mm).

### Inventive Examples 1 to 4

Components A, B, C, D and E were melted (see table 1) at from 220 to 240° C. and 130 bar in a Leitritz ZSK 18 twin-screw extruder. 7.5 parts of S pentane (20% of isopentane, 80% of n-pentane) were then injected as blowing agent into the polymer melt, and homogeneously incorporated into the polymer melt by way of two static mixers. The temperature was then reduced to from 180° to 185° C. by way of a cooler. 1 part of talc, in the form of a masterbatch, was fed by way of an ancillary extruder as nucleating agent into the main melt stream loaded with blowing agent. After homogenization by way of two further static mixers, the melt was cooled to 140° C. and extruded through a heated pelletizing die (4 holes with 0.65 mm bore and pelletizing-die temperature of 280° C.). The polymer strand was chopped by means of an underwater pelletizer (underwater pressure 12 bar, water temperature 45° C.), thus giving minipellets loaded with blowing agent and having narrow particle size distribution (d′=1.1 mm).

### Inventive Examples 5 to 7

Components A, B, C, D and E were melted (see table 1) at from 220 to 240° C. and 130 bar in a Leitritz ZSK 18 twin-screw extruder. 7.5 parts of S pentane (20% of isopentane, 80% of n-pentane) were then injected as blowing agent into the polymer melt, and homogeneously incorporated into the polymer melt by way of two static mixers. The temperature was then reduced to from 180° to 185° C. by way of a cooler. 1 part of talc, in the form of a masterbatch, was fed by way of an ancillary extruder as nucleating agent into the main melt stream loaded with blowing agent. After homogenization by way of two further static mixers, the melt was cooled to 140° C. and extruded through a heated pelletizing die (4 holes with 0.65 mm bore and pelletizing-die temperature of 280° C.). The polymer strand was chopped by means of an underwater pelletizer (underwater pressure 12 bar, water temperature 45° C.), thus giving minipellets loaded with blowing agent and having narrow particle size distribution (d′=1.1 mm).

### Inventive Example 8

In a Leistritz ZSK 18 twin-screw extruder, 73 parts of polystyrene 168N, 8 parts of polyethylene 726N, 5 parts of Engage 8411 polyethylene, and 1.75 parts of Kraton G1650, and 11.5 parts of component C1-1 were melted at from 220 to 240° C. and from 200 to 210 bar, 7.5 parts of S pentane (20% of isopentane, 80% of n-pentane) were then injected as blowing agent into the polymer melt, and homogeneously incorporated into the polymer melt by way of two static mixers. The temperature was then reduced to from 190° to 195° C. by way of a cooler. 1 part of talc, in the form of a masterbatch, was fed by way of an ancillary extruder as nucleating agent (see table 1) into the main melt stream loaded with blowing agent. After homogenization by way of two further static mixers, the melt was cooled to 155° C. and extruded through a heated pelletizing die (4 holes with 0.65 mm bore and pelletizing-die temperature of 280° C.). The polymer strand was chopped by means of an underwater pelletizer (underwater pressure 12 bar, water temperature 45° C.), thus giving minipellets loaded with blowing agent and having narrow particle size distribution (d′=1.1 mm).

### Inventive Example 9

In a Leistritz ZSK 18 twin-screw extruder, 61 parts of polystyrene 168N, 8 parts of polyethylene 726N, 5 parts of Engage 8411 polyethylene, and 1.75 parts of Kraton G1650, and 12.5 parts of component C1-1, and 10.5 parts of Styrolux 3G55 were melted at from 220 to 240° C. and from 200 to 210 bar. 7.5 parts of S pentane (20% of isopentane, 80% of n-pentane) were then injected as blowing agent into the polymer melt, and homogeneously incorporated into the polymer melt by way of two static mixers. The temperature was then reduced to from 190° to 195° C. by way of a cooler. 1 part of talc, in the form of a masterbatch, was fed by way of an ancillary extruder as nucleating agent (see table 1) into the main melt stream loaded with blowing agent. After homogenization by way of two further static mixers, the melt was cooled to 155° C. and extruded through a heated pelletizing die (4 holes with 0.65 mm bore and pelletizing-die temperature of 280° C.). The polymer strand was chopped by means of an underwater pelletizer (underwater pressure 12 bar, water temperature 45° C.), thus giving minipellets loaded with blowing agent and having narrow particle size distribution (d′=1.1 mm).

The pellets loaded with blowing agent were prefoamed in an EPS prefoamer to give foam beads of low density (from 15 to 25 g/L), and processed in an automatic EPS molding machine at a gage pressure of from 0.7 to 1.1 bar, to give moldings.

Various mechanical tests were carried out on the moldings, in order to demonstrate the elasticification of the foam. Table 3 shows the compression set εₛₑₜ of the foam moldings, determined from simple hysteresis at 75% compression (advance rate 5 mm/min) to ISO 3386-1. Compression set εₛₑₜ is the percentage proportion by which the compressed body fails to resume its initial height after 75% compression. In the inventive examples, marked elastification is observed in comparison with the straight EPS, discernible from the very high resilience.

Compressive strength at 10% compression was also determined to DIN-EN 826, as was flexural strength to DIN-EN 12089. Bending energy was also determined during the flexural strength tests.

Coating components used comprised 70% by weight of glycerol tristearate (GTS) and 30% by weight of glycerol monostearate (GMS). The coating composition had a favorable effect on the fusion of the prefoamed foam beads to give the molding. Flexural strength was increased to 250 and, respectively, 310 kPa, in comparison with 150 kPa for the moldings obtained from the uncoated pellets.

The small bead sizes of 0.8 mm showed an improvement in processability to give the molding, in relation to demolding times and behavior during filling of the mold. The surface of the molding was moreover more homogeneous than in the case of beads of diameter 1.1 mm.

TABLE 1
Table 1: Constitution of expandable polymer beads (EPS) in proportions by weight, and properties of foam moldings

| Examples | CE1 | 1 | 2 | 3 | 4 | 5 | 6 | 7 | 8 | 9 |
|---|---|---|---|---|---|---|---|---|---|---|
| Constitution | | | | | | | | | | |
| Comp. A GPPS grade | 158K | 158K | 158K | 158K | 158K | 158K | 158K | 158K | 168N | 168N |
| Comp. A [% by wt.] | 84 | 78 | 73 | 65 | 61 | 73 | 61 | 50 | 73 | 61 |
| Comp. B1 [% by wt.] | 8 | 8 | 8 | 8 | 8 | 8 | 8 | 8 | 8 | 8 |
| Comp. B2 [% by wt.] | 5 | 5 | 5 | 5 | 5 | 5 | 5 | 5 | 5 | 5 |
| Comp. C1 [% by wt.] | | 6.25 | 11.50 | 18.75 | 22.75 | 6.25 | 12.5 | 18.75 | 11.5 | 12.5 |
| Comp. C2 [% by wt.] | | | | | | 5.25 | 10.5 | 15.75 | | 10.5 |
| Comp. C3 [% by wt.] | 1.75 | 1.75 | 1.75 | 1.75 | 1.75 | 1.75 | 1.75 | 1.75 | 1.75 | 1.75 |
| Comp. D [% by wt.] | 7.5 | 7.5 | 7.5 | 7.5 | 7.5 | 7.5 | 7.5 | 7.5 | 7.5 | 7.5 |
| Comp. E [% by wt.] | 1 | 1 | 1 | 1 | 1 | 1 | 1 | 1 | 1 | 1 |
| Foam properties | | | | | | | | | | |
| Foam density [g/L] | 22.0 | 21.8 | 22.6 | 23.5 | 26.6 | 22.8 | 22.5 | 33.0 | 23.8 | 25.5 |
| Compressive strength at 10% [kPa] | 103 | 103 | 100 | 110 | 106 | 112 | 109 | 116 | 130 | 116 |
| Flexural strength [kPa] | 301 | 287 | 293 | 308 | 313 | 299 | 301 | 330 | 322 | 330 |
| Bending energy [Nm] | 4.6 | 5.1 | 5.5 | 6.0 | 6.7 | 5.6 | 5.8 | 7.4 | 6.0 | 7.4 |
| Compression set [%] | 32 | 30 | 33 | 31 | 32 | 28 | 28 | 32 | 29 | 32 |

1.-12. (canceled)

13. An expandable, thermoplastic polymer bead material, comprising
A) from 45 to 97.8 percent by weight of a styrene polymer,
B1) from 1 to 45 percent by weight of a polyolefin with a melting point in the range from 105 to 140° C.,
B2) from 0 to 25 percent by weight of a polyolefin with a melting point below 105° C.,
C1) from 0.1 to 25 percent by weight of a block or graft copolymer with weight-average molar mass M_{w} of at least 100,000 g/mol, comprising
a) at least one block S composed of from 95 to 100% by weight of vinylaromatic monomers and from 0 to 5% by weight of dienes, and
b) at least one copolymer block (S/B)_{A} composed of from 63 to 80% by weight of vinylaromatic monomers and from 20 to 37% by weight of dienes, with glass transition temperature Tg_{A} in the range from 5 to 30° C., where
the proportion by weight of the entirety of all of the blocks S is in the range from 50 to 70% by weight, based on the block or graft copolymer A,
C2) from 0 to 20 percent by weight of a styrene-butadiene or styrene-isoprene block copolymer different from C1,
C3) from 0.1 to 9.9 percent by weight of a styrene-ethylene-butylene block copolymer,
D) from 1 to 15 percent by weight of a blowing agent, and
E) from 0 to 5 percent by weight of a nucleating agent,
where the entirety composed of A) to E) gives 100% by weight.

14. The expandable, thermoplastic polymer bead material according to claim 13, which comprises
A) from 55 to 89.7 percent by weight of a styrene polymer,
B1) from 4 to 25 percent by weight of a polyolefin with a melting point in the range from 105 to 140° C.,
B2) from 1 to 15 percent by weight of a polyolefin with a melting point below 105° C.,
C1) from 3 to 25 percent by weight of the block or graft copolymer,
C2) from 3 to 20 percent by weight of a styrene-butadiene or styrene-isoprene block copolymer different from C1,
C3) from 1 to 5 percent by weight of a styrene-ethylene-butylene block copolymer,
D) from 3 to 10 percent by weight of a blowing agent, and
E) from 0.3 to 3 percent by weight of a nucleating agent,
where the entirety composed of A) to E) gives 100% by weight.

15. The expandable, thermoplastic polymer bead material according to claim 13, which comprises, as styrene polymer A), standard polystyrene (GPPS).

16. The expandable, thermoplastic polymer bead material according to claim 13, which comprises, as polyolefin B1), polyethylene.

17. The expandable, thermoplastic polymer bead material according to claim 13, which comprises, as polyolefin B2), a copolymer composed of ethylene and octene.

18. The expandable, thermoplastic polymer bead material according to claim 13, wherein the block or graft copolymer C1 has a linear structure having the block sequence S₁-(S/B)_{A}-S₂-(S/B)_{A}-S₃, where each of S₁, S₂ and S₃ is a block S.

19. The expandable, thermoplastic polymer bead material according to claim 13, wherein the entirety of C1, C2, and C3 is in the range from 3.5 to 40 percent by weight.

20. The expandable, thermoplastic polymer bead material according to claim 13, wherein the average diameter of the disperse phase of the polymer mixture is in the range from 1 to 1500 nm.

21. The expandable, thermoplastic polymer bead material according to claim 13, which has a coating, comprising a glycerol stearate.

22. A process for the production of expandable, thermoplastic polymer bead material according to claim 13, which comprises
a) producing a polymer melt with a continuous and a disperse phase via mixing of components A) to C) and optionally E),
b) impregnating this polymer melt with a blowing agent D), and
c) pelletizing via underwater pelletization at a pressure of from 1.5 to 10 bar, to give expandable thermoplastic polymer bead material.

23. A process for the production of expandable, thermoplastic polymer bead material according to claim 13, which comprises
a) producing a polymer melt with a continuous and a disperse phase via mixing of components A) to C) and optionally E),
b) impregnating this polymer melt with a blowing agent D), and
c) pelletizing this polymer melt and post-impregnating it in an aqueous phase under pressure and at an elevated temperature with a blowing agent D) to give expandable thermoplastic polymer bead material.

24. The process according to claim 22, wherein, in stage b), the amount used of a C₃-C₈ hydrocarbon as blowing agent is from 1 to 10 percent by weight, based on the polymer mixture.
